(19) United States
(12) Patent Application Publication
(10) Pub. No.: US 2003/0014730 A1
(43) Pub. Date: Jan. 16, 2003

(54) Transfer mask blank, transfer mask and exposure method

(76) Inventor: Shin-ichi Takahashi, Tokyo (JP)

Correspondence Address: KLARQUIST SPARKMAN, LLP, 121 SW SALMON STREET, SUITE 1600, PORTLAND, OR, 97204, US

(21) Appl. No.: 10/204,872

(22) PCT Filed: Dec. 25, 2001
(86) PCT No.: PCT/JP01/11357

(30) Foreign Application Priority Data
Dec. 26, 2000 (JP) 2000-394413

(51) Int. Cl. G06F 17/50

(52) U.S. Cl. 716/19

(57) ABSTRACT

A transfer mask blank according to the present invention, comprises: a supporting substrate having a strut; a silicon oxide layer formed on the supporting substrate; and a silicon membrane formed on the silicon oxide layer; wherein: an average value of concentration of phosphorus in said silicon membrane is defined between 5×10¹⁸ atom/cm³ and 1×10²⁰ atom/cm³; and also, a uniformity of the concentration of phosphorus in said silicon membrane is lower than, or equal to 20% and can make stress of the silicon membrane to be readily set to a proper stress value, whereby both a warp of the pattern and a distortion of the pattern can be easily suppressed.

### TECHNICAL FIELD

The present invention is mainly related to a transfer mask and a transfer mask blank, which are used in a lithography apparatus by way of a charged particle beam such as an electron beam and an ion beam in manufacturing of semiconductor integrated circuits.

### BACKGROUND ART

Very recently, while integrated circuits are manufactured in high integration, instead of exposure method (photolithography techniques) using light, which had constituted the major means for forming very fine patterns for long time, novel exposure methods using a charged particle beam, such as an electron beam or an ion beam, or a X-ray have been investigated, and may be gradually utilized in practical fields. Among these methods, an electron beam exposure system which forms a pattern by utilizing an electron beam may own such a great feature that since the electron beam itself can be focused narrow up to several nm, very fine patterns narrower than, or equal to 0.1 μm can be formed.

However, since the conventionally-used electron beam exposure method is a “direct-writing” method, it is necessary to draw by using a more focused electron beam, as the pattern becomes fine. This may cause the drawing time to be lengthened, so that throughput is largely reduced.

Then, another exposure method has been conceived by which a transfer mask is employed and a small region (subfield) is exposed at once. As the transfer mask, a scattering-stencil mask has been proposed in which an opening for an electron beam transmission portion is formed in a membrane-shaped silicon having a thickness of approximately 2 μm. The scattering-stencil mask is sectioned into a plurality of subfields by lattice-shaped struts, which are called as “struts”. Since a dimension of the subfield which is exposed by an electron beam of one time is nearly equal to an 1-mm square in size, in order to expose the entire area of the semiconductor chip, the respective subfields are scanned in the stepwise manner by using the electron beam, and the patterns corresponding to the openings of the subfields are stitched together on the sensitive substrate.

The transfer mask is generally manufactured by the below-mentioned method. FIG. 5(a) to FIG. 5(f) are sectional drawings for showing a method of manufacturing both a transfer mask blank and a transfer mask, which are made of a general-purpose silicon membrane.

First, as shown in FIG. 5(a), an SOI (Silicon on insulator) wafer is prepared, which is constituted by a silicon supporting substrate 1, a silicon oxide layer 3 formed on the silicon supporting substrate 1, a silicon active layer 2 formed on the silicon oxide layer 3. Since the silicon active layer 2 of the normal SOI wafer has compression stress, when the silicon active layer 2 is made to be self-supported thin film(to be membrane), it is buckled. So, such an impurity as boron is diffused into the silicon active layer 2 (by way of either a thermal diffusing method or an ion implanting method) so as to control stress of the silicon membrane. As a result, a silicon membrane layer into which boron has been diffused is formed on the silicon oxide layer 3 (FIG. 5(b)).

Thereafter, a resist 5 is coated on the silicon supporting substrate 1 as a mask used in silicon etching, and after being processing in a lithography step, a portion 6 corresponding to the subfield is patterned (FIG. 5(c)).

Next, the silicon supporting substrate 1 of the subfield corresponding portion 6 is removed by way of an etching process, so that both an outer peripheral portion of the silicon supporting substrate 1 and a lattice-shaped strut 7 are formed. This etching process is carried out up to the silicon oxide layer 3 which is an etching stop layer(FIG. 5(d)).

Next, a silicon oxide of the subfield corresponding portion 6 is removed by way of an etching process, so that a transfer mask blank is completely formed (FIG. 5(e)). Finally, a resist is coated on the silicon membrane and a very fine pattern which should be transferred to a sensitive substrate is transferred on the resist by employing an exposing apparatus such as an electron beam drawing apparatus. And then, the silicon membrane is removed by using the resist as an etching-purpose mask so as to form a pattern opening 8, whereby a transfer mask is manufactured(FIG. 5(f)).

On the other hand, the transfer mask blank which is manufactured in accordance with the above-described manufacturing method (FIG. 5) by employing the wafer having the silicon membrane into which boron has been diffused, has serious problems. That is to say, these problems are warp of the membrane due to unequal stress along the depth direction thereof, which is caused by the unequal distribution of the boron concentration along the depth direction, and also distortion of the pattern due to high tensile stress.

To solve these problems, by setting both the average boron concentration and the boron concentration distribution along the depth direction in the silicon membrane to a proper range, the warp of the membrane and the distortion of the pattern can be suppressed (refer to Japanese Laid-open Patent Application No. Hei-12-206675).

However, in such a case that boron is used as the impurity for controlling stress of the silicon membrane, since the stress of the silicon membrane is largely changed by slightly changing the boron concentration, another problem such that the stress of the silicon membrane can be difficultly controlled to have a proper stress value is occurred.

The present invention has been made to solve this problem, and therefore, has an subject to provide both a transfer mask blank and a transfer mask, capable of easily setting stress of a silicon membrane to a proper stress value, and also, capable of readily suppressing a warp of a pattern and a distortion of a pattern.

### DISCLOSURE OF THE INVENTION

The Inventors of the present invention, as a result of the deepest research, used phosphorus as an impurity for controlling stress of a silicon membrane and could find out allowable conditions of using phosphorus.

In other words, from viewpoint for reducing the tensile stress as low as possible, the Inventors could have such a recognition that the above-described object can be achieved by defining an average value of phosphorus concentration between approximately 5×10¹⁸ atom/cm³ and 1×10²⁰ atom/cm³.

Furthermore, the Inventors have investigated an allowable range for the warp of membrane caused by concentration distribution in the case that phosphorus was diffused within this average concentration range. As a result, the Inventors could find out such a fact that within a range where a uniformity of phosphorus concentration is lower than, or equal to 20%, preferably lower than, or equal to 15%, no warp of the membrane occurs. The uniformity of the phosphorous concentration is defined by the below-mentioned formula:

uniformity (%) of phosphorus concentration=(maximum value of phosphorus concentration−minimum value of phosphorus concentration)×100/(average value of phosphorus concentration×2).

As a consequence, a first aspect of the present invention (claim 1) is to provide a transfer mask blank comprising: a supporting substrate having a strut; a silicon oxide layer formed on the supporting substrate; and a silicon membrane formed on the silicon oxide layer; wherein: an average value of the concentration of phosphorus in said silicon membrane is defined between 5×10¹⁸ atom/cm³ and 1×10²⁰ atom/cm³; and also, a uniformity of the concentration of phosphorus in said silicon membrane is lower than, or equal to 20%.

Also, a second aspect of the present invention(claim 2) is to provide a transfer mask comprising: a supporting substrate having a strut; a silicon oxide layer formed on the supporting substrate; and a silicon membrane which is formed on the silicon oxide layer, and on which a pattern is formed; wherein: an average value of the concentration of phosphorus in said silicon membrane is defined between 5×10¹⁸atom/cm³ and 1×10²⁰ atom/cm³; and also, a uniformity of the concentration of phosphorus in said silicon membrane is lower than, or equal to 20%.

Also, a third aspect of the present invention(claim 3) is to provide such a transfer mask blank as claimed in claim 1, or a transfer mask as claimed in claim 2, wherein: a thickness of said silicon oxide layer is defined between 1 μm and 2 μm.

Also, a fourth aspect of the present invention (claim 4) is to provide a charged particle beam exposing method that a charged particle beam generated from a charged particle beam source is irradiated onto a transfer mask having a predetermined pattern, and an image of said pattern is projected and focused onto a sensitive substrate; wherein: said transfer mask comprising: a supporting substrate having a strut; a silicon oxide layer formed on the supporting substrate; and a silicon membrane which is formed on the silicon oxide layer, and on which a pattern is formed; and wherein: an average value of the concentration of phosphorus in said silicon membrane is between 5×10¹⁸ atom/cm³ and 1×10²⁰ atom/cm³; and also, a uniformity of the concentration of phosphorus in said silicon membrane is lower than, or equal to 20%.

Also, a fifth aspect of the present invention (claim 5) is to provide a manufacturing method of manufacturing a transfer mask blank comprising: a supporting substrate having a strut; a silicon oxide layer formed on the supporting substrate; and a silicon membrane formed on the silicon oxide layer, wherein: the manufacturing method is comprised of: a step in which phosphorus is diffused into said silicon membrane whereby an average value of the concentration of phosphorus in the silicon membrane is made between 5×10¹⁸ atom/cm³ and 1×10²⁰ atom/cm³; the concentration of phosphorus in said silicon membrane is made uniform; and a uniformity of the phosphorus concentration is made lower than, or equal to 20%.

Also, a sixth aspect of the present invention (claim 6) is to provide a manufacturing method of manufacturing a transfer mask comprising: a supporting substrate having a strut; a silicon oxide layer formed on the supporting substrate; and a silicon membrane which is formed on the silicon oxide layer, and on which a pattern is formed; wherein: the manufacturing method is comprised of: a step in which phosphorus is diffused into said silicon membrane whereby an average value of the concentration of phosphorus in the silicon membrane is made between 5×10¹⁸ atom/cm³ and 1×10²⁰ atom/cm³; the concentration of phosphorus in the silicon membrane is made uniform; and a uniformity of the phosphorus concentration is made lower than, or equal to 20%.

Also, a seventh aspect of the present invention (claim 7) is to provide a method of manufacturing a transfer mask blank as claimed in claim 5, or a method of manufacturing a transfer mask as claimed in claim 6, wherein: the manufacturing method is comprised of: a step for anneal-processing said transfer mask blank within an active gas atmosphere.

### BRIEF DESCRIPTION OF THE DRAWINGS

FIG. 1 is a drawing for showing a concentration distribution of phosphorus to a depth direction in a silicon membrane of a transfer mask blank according to an embodiment of the present invention.

FIG. 2 is a drawing for showing stress with respect to concentration of an impurity which is diffused into a silicon membrane of a transfer mask blank, the impurity being either phosphorus according to the present invention or boron according to the prior art.

FIG. 3 is a drawing for showing a concentration distribution of phosphorus to a depth direction in a silicon membrane of a transfer mask blank manufactured by the prior art.

FIG. 4 is a schematic drawing for showing an electron beam exposing apparatus corresponding to one sort of charged particle exposing apparatus which executes a charged particle beam exposing method according to the present invention.

FIG. 5 is an explanatory diagram for showing a method of manufacturing both a transfer mask blank and a transfer mask according to the prior art.

### DESRIPTION OF REFERENCE NUMERALS

1—silicon supporting substrate; 2—silicon active layer; 3—silicon oxide layer; 5—resist; 6—subfields corresponding portion; 7—strut; 8—pattern opening; 17—sensitive substrate; 17A—processing plane; 121—electron gun; 122—condenser lens system; 123—beam forming aperture; 124—illumination beam deflector; 125—illumination lens; 126—transfer mask; 127—transfer mask stage; 128, 133—projection lens; 129—deflector

### BEST MODE FOR CARRYING OUT THE INVENTION

Referring now to drawings, embodiment modes of the present invention will be described.

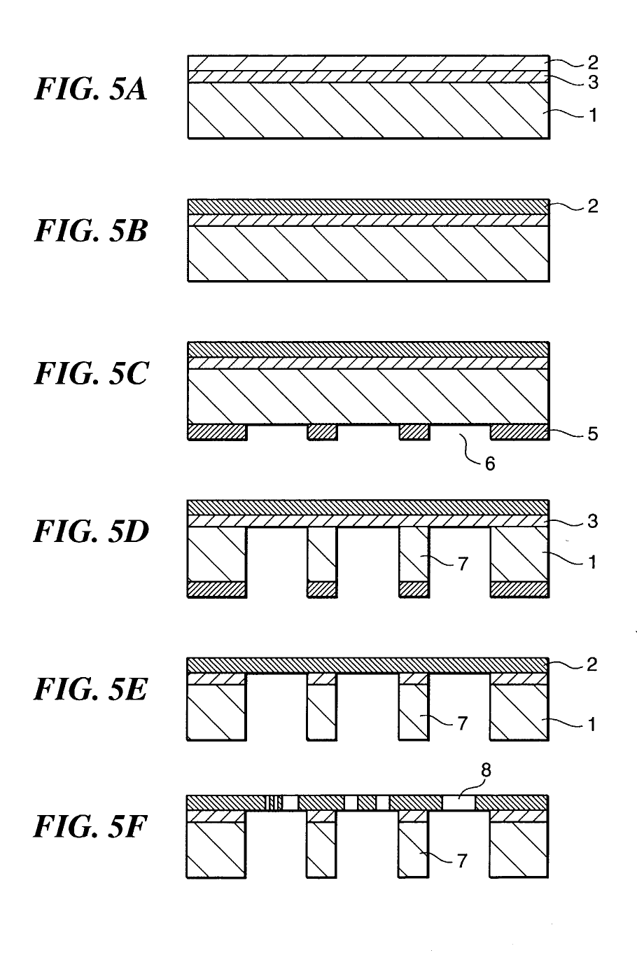

A transfer mask blank, according to a first embodiment of the present invention, is constituted by, as shown in FIG. 5(e), a silicon membrane made of a silicon active layer 2 into which phosphorus has been diffused, a silicon supporting substrate 1 which supports the membrane at an outer peripheral portion thereof, and a lattice-shaped strut 7.

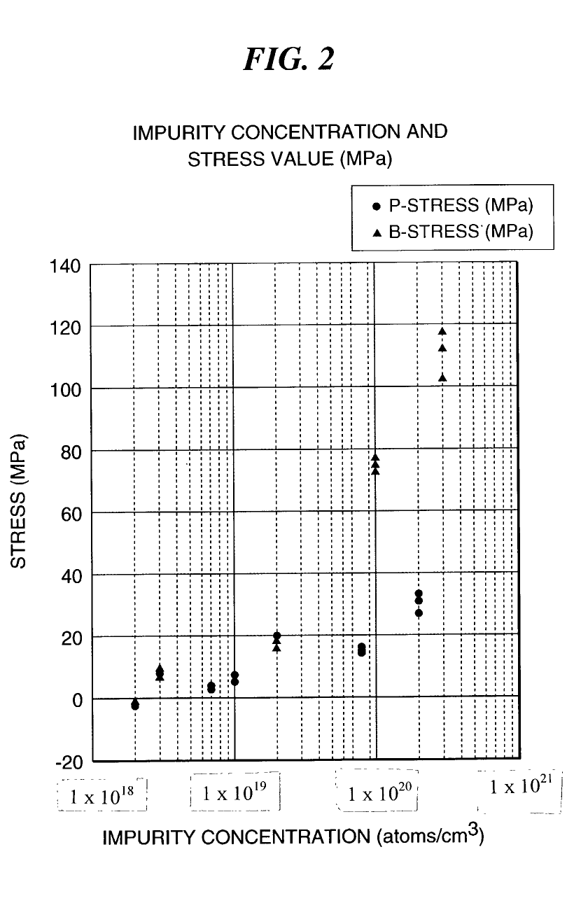

FIG. 2 is a drawing for showing stress with respect to concentration of an impurity which is diffused into the silicon membrane of the transfer mask blank, the impurity being either phosphorus (P) according to the present invention or boron(B) according to the prior art. In FIG. 2, an abscissa axis shows the concentration of the impurities (atoms/cm³), and the ordinate axis shows stress (MPa). Also, in FIG. 2, symbol “●” shows a change in stress in the case that phosphorus (P) according to the present invention is diffused as the impurity, and also, symbol “▴” shows a change in stress in the case that boron (B) according to the prior art is diffused as the impurity. While stress of the silicon membrane is changed in response to the concentration of the impurity, it is found out that as to the change amount of the stress with respect to the change in the concentration of the impurity, the change amount in the case that phosphorus according to the present invention is used as the impurity becomes smaller than that in the case that boron according to the prior art is used as the impurity. In other words, in such a case that the impurity concentration is equal to 10¹⁹ atoms/cm³, stress occurred when boron (B) is diffused as the impurity substantially equals to stress occurred when phosphorus (P) is diffused as the impurity. In contrast, in such a case that the concentration of the impurity is equal to 10²⁰ atoms/cm³, it is found out that the change amount of stress occurred in the case that phosphorus (P) according to the present invention is diffused as the impurity is smaller than that occurred in the case that boron (B) is diffused as the impurity. That is to say, it can be seen that even when the phosphorus concentration may be more or less changed, stress of the silicon membrane is not so changed. Accordingly, by using phosphorous (P) as the impurity which is diffused in to the silicon membrane, the stress of the silicon membrane can be easily brought into a proper stress value, so that a warp of a pattern and a distortion of a pattern may be readily suppressed.

Then, a transfer mask blank was manufactured by using the manufacturing method shown in FIG. 5 under such a condition that phosphorus was diffused in the silicon membrane, whereby an average value of phosphorus concentration in the silicon membrane was made between 5×10^{18 atom/cm}³ and 1×10²⁰ atom/cm³, the phosphorus concentration in the above-described silicon membrane was made uniform, and also, the uniformity of the phosphorus concentration was made lower than, or equal to 20%.

As such a method by which phosphorus is diffused in the silicon membrane whereby the average value of the phosphorus concentration in the silicon membrane is made between 5×10¹⁸ atom/cm³ and 1×10²⁰ atom/cm³, the phosphorus concentration in the above-described silicon membrane is made uniform, and also, the uniformity of the phosphorus concentration is made lower than, or equal to 20%, for example, an open-tube diffusion method has been proposed. This open-tube diffusion method is a method that a fluid of POCl₃ is vaporized within a diffusion furnace and the vaporized POCl₃ is caused to flow in combination with nitrogen gas to form phosphorus glass on a surface of a wafer, and thereafter, the wafer is thermally diffused for 40 minutes at a temperature of 850° C.

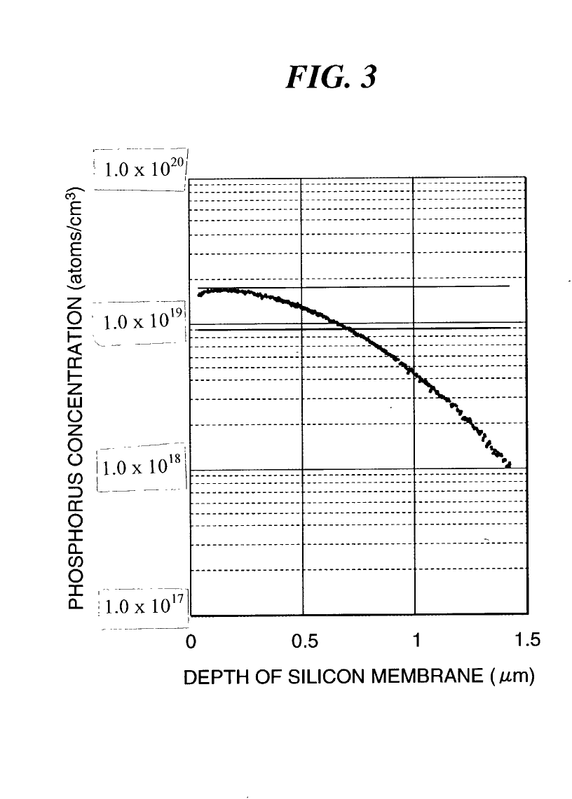

FIG. 3 is a drawing for showing a concentration distribution of phosphorus to a depth direction in the silicon membrane of the transfer mask blank. The ordinate axis shows the phosphorus concentration, and the abscissa axis shows the depth while the topmost surface (diffusion plane of phosphorus) of the membrane is assumed as “0” in the depth. From this drawing, a phosphorus concentration located more or less deeper from the topmost surface of the membrane is highest. Also, the deeper the membrane portion is located, the lower the phosphorus concentration becomes. At this time, the uniformity of the phosphorus concentration is on the order of 90%. In this case, in the vicinity of the membrane surface where the phosphorus concentration is high, tensile stress becomes larger than that of the inner portion of the membrane so that when a pattern is formed on the silicon membrane, this silicone membrane is warped to the surface side thereof, whereby the pattern is warped. At this time, the warp amount is approximately 5 μm, and cannot be practically accepted, which may cause a certain problem.

Next, a transfer mask blank according to the embodiment of the present invention was manufactured by adding such an anneal-processing step to the manufacturing method of FIG. as previously explained in the conventional technique. The anneal-processing is carried out within an active gas (for example, N₂ etc.) atmosphere. The condition of this anneal-processing is given as follows:

For example, the anneal-processing is carried out for 8 hours at the temperature of 1,150° C. As a result, internal stress of approximately 50 MPa is reduced lower than, or equal to 10 MPa.

The condition, for instance, temperature and time cycle, of the anneal-processing is determined based upon a membrane thickness of the silicon membrane, and a diffusion amount of phosphorus. Also, by selecting a thickness of the silicon oxide layer to be a proper thickness (for example, 1 to 2 μm), this silicon oxide layer may constitute a barrier, so that the phosphorus concentration can be uniformly distributed in the silicon active layer.

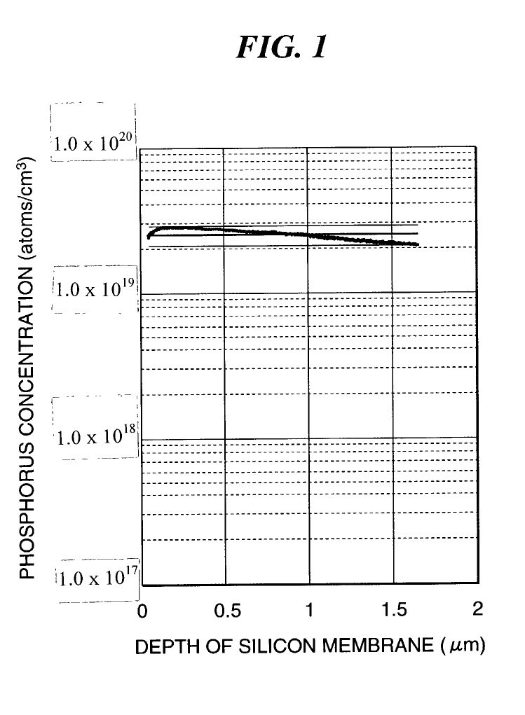

FIG. 1 is a drawing for showing a concentration distribution of phosphorus to a depth direction in the silicon membrane of a transfer mask blank according to the embodiment of the present invention. The ordinate axis shows the concentration of phosphorus, and the abscissa axis shows a depth while the topmost surface (diffusion plane of phosphorus) of the membrane is assumed as “0.” Phosphorus concentration in the silicon membrane is 2.5×10¹⁹ atoms/cm³. And, phosphorus is substantially uniformly distributed in the silicon membrane and a uniformity of the phosphorus concentration to the depth is within 20%. Here, the uniformity of the phosphorous concentration is defined by the below-mentioned formula:

uniformity (%) of phosphorus concentration=(maximum value of phosphorus concentration−minimum value of phosphorus concentration)×100/(average value of phosphorus concentration×2).

As a result, the tensile stress may be suppressed lower than, or equal to approximately 10 MPa, and even after a pattern has been formed on the silicon membrane, a distortion of a pattern may be suppressed smaller than, or equal to 10 nm. Also, since a distribution of the tensile stress along the depth direction may be suppressed to low, such a problem that the pattern is warped may be solved. An amount of the warp is smaller than, or equal to 0.3 μm, which may be sufficiently utilized in the practical field.

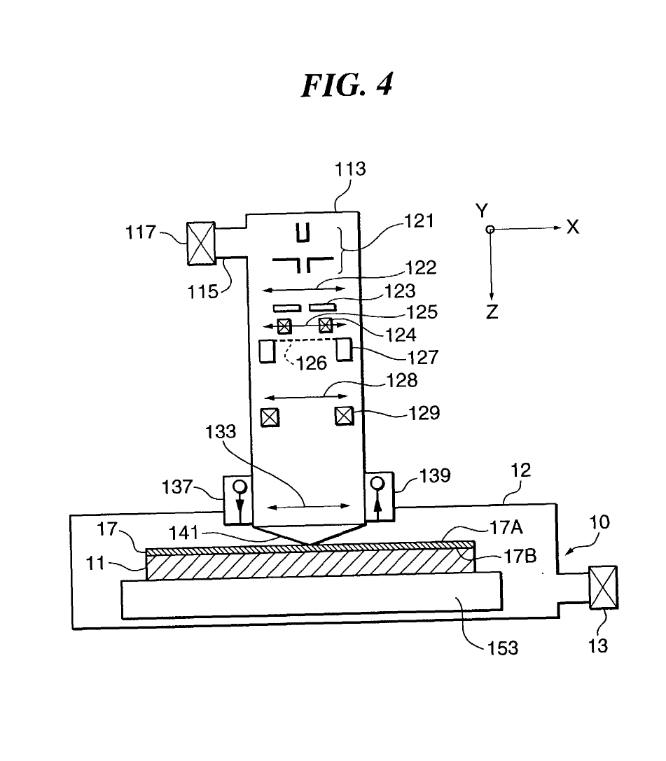

Next, a charged particle exposing method according to the present invention will now be explained with reference to FIG. 4.

FIG. 4 is a schematic drawing of an electron beam exposing apparatus corresponding to one sort of charged particle exposing apparatus which executes the charged particle exposing method according to the present invention. An electron gun 121 which is arranged at the uppermost stream of an optical system emits an electron beam along a downward direction. A condenser lens system 122 is provided under the electron gun 121. An illumination beam forming aperture 123 is provided under the condenser lens system 122. An image of the illumination beam forming aperture 123 is focused onto a transfer mask 126 by an illumination lens 125. Then, the illumination beam forming aperture 123 causes only such an illumination beam which illuminates a single subfield (unit exposing pattern region) of the transfer mask 126 to be passed.

A blanking deflector (not shown), a blanking aperture (not shown), an illumination beam deflector 124, and the like are arranged under the illumination beam forming aperture 123. In the case that the illumination beam is not required to be irradiated to the transfer mask 126, the blanking deflector deflects the illumination beam so as to cause the deflected illumination beam to impinge on a non-opening portion of the blanking aperture, so that the illumination beam does not impinge on the transfer mask 126. The illumination beam deflector 124 causes the illumination beam to be sequentially scanned along the X direction of FIG. 4 so as to illuminate the respective subfields of the transfer mask 126 which is located within a field of view of the illumination optical system.

Also, an illumination lens 125 is arranged under the illumination beam forming aperture 123. The illumination lens 125 collimates the electron beam and the collimated electron beam impinges on the transfer mask 126 whereby the image of the beam forming aperture 123 is focused onto the transfer mask 126.

The transfer mask 126 corresponding to the transfer mask according to the present invention lies in a plane (in X-Y plane) perpendicular to the optical axis and has a large number of subfields, as previously explained. Patterns (chip patterns) which constitute a single piece of semiconductor device as a whole are formed on the transfer mask 126.

A peripheral portion of the transfer mask 126 is held on a transfer mask stage 127 capable of transporting along the X-Y direction. In order to illuminate the respective subfields over the field of view of the illumination optical system, the transfer mask 126 is mechanically transported. Incidentally, when the respective subfields are illuminated within the field of view of the illumination optical system, as explained in the above-description, the electron beam may be deflected by the deflector 124.

A projection lens 128, 133, a deflector 129, and the like are provided under the transfer mask 126. On impinging an illumination beam on a subfield in the transfer mask 126, an electron beam which pass through a pattern portion of the transfer mask 126 is demagnified by both the projection lenses 128 and 133, and also, is deflected by the respective lenses and the deflector 129, and then, is focused onto a predetermined position of a processing plane 17A (upper plane) of a sensitive substrate 17. Since a suitable resist (not shown) has been coated on this processing plane 17A, when a dose of the electron beam is given on the resist, the patterns formed on the transfer mask 126 are demagnified and transferred onto the sensitive substrate 17.

Since the above-described charged particle beam exposing method employs the transfer mask in which wraps of the patterns and distortions of the patterns are suppressed, a desirable pattern can be transferred onto the sensitive substrate.

As previously explained, in accordance with the transfer mask blank of the present invention, since phosphorus is employed as the impurity for controlling the stress of the silicon membrane, the change amount of the stress of the silicon membrane with respect to the change in the impurity concentration may be decreased, so that the stress may be easily set to the proper value.

Also, since the average value of the phosphorus concentration in the silicon membrane is set to a range between 5×10¹⁸ atom/cm³ and 1×10²⁰ atom/cm³, the tensile stress of the silicon membrane may be suppressed to be low, and even after the patterns to be transferred to the sensitive substrate have been formed on the silicon membrane, the distortions of the patterns within the plane may be suppressed to the minimum.

Furthermore, since the uniformity of the phosphorus concentration to the depth direction is set within the range lower than, or equal to 20%, the unequal distribution of the tensile stress strengths of the silicon membrane along the depth direction may be suppressed, so that the warp of the silicon membrane does not occur. Also, even after the patterns to be transferred to the sensitive substrate have been formed on the silicon membrane, the warps of the patterns can be suppressed.

In other words, as a result of such a fact that the warps of the patterns which are caused by the unequal distribution of the stress along the depth direction may be suppressed and also the distortion of the patterns which are caused by the high tensile stress may be suppressed, both the transfer mask blank and the transfer mask can be provided, that can satisfy the requirements as to the pattern precision defined by on the order of ten and several nm, and also the positional distortion precision, which are required so as to manufacture the integrated circuits in very fine techniques.

1. A transfer mask blank comprising:
a supporting substrate having a strut;
a silicon oxide layer formed on the supporting substrate; and
a silicon membrane formed on the silicon oxide layer; wherein:
an average value of the concentration of phosphorus in said silicon membrane is defined between 5×10¹⁸ atom/cm³ and 1×10²⁰ atom/cm³; and also, a uniformity of the concentration of phosphorus in said silicon membrane is lower than, or equal to 20%.

2. A transfer mask comprising:
a supporting substrate having a strut;
a silicon oxide layer formed on the supporting substrate; and
a silicon membrane which is formed on the silicon oxide layer, and on which a pattern is formed; wherein:
an average value of the concentration of phosphorus in said silicon membrane is defined between 5×10¹⁸ atom/cm³ and 1×10²⁰ atom/cm³; and also, a uniformity of the concentration of phosphorus in said silicon membrane is lower than, or equal to 20%.

3. A transfer mask blank as claimed in claim 1, or a transfer mask as claimed in claim 2, wherein:
a thickness of said silicon oxide layer is defined between 1 μm and 2 μm.

4. A charged particle beam exposing method that a charged particle beam generated from a charged particle beam source is irradiated onto a transfer mask having a predetermined pattern, and an image of said pattern is projected and focused onto a sensitive substrate; wherein:
said transfer mask comprising: a supporting substrate having a strut; a silicon oxide layer formed on the supporting substrate; and a silicon membrane which is formed on the silicon oxide layer, and on which a pattern is formed; and wherein:
an average value of the concentration of phosphorus in said silicon membrane is between 5×10¹⁸ atom/cm³ and 1×10² atom/cm³; and also, a uniformity of the concentration of phosphorus in said silicon membrane is lower than, or equal to 20%.

5. A manufacturing method of manufacturing a transfer mask blank comprising: a supporting substrate having a strut; a silicon oxide layer formed on the supporting substrate; and a silicon membrane formed on the silicon oxide layer, wherein:
the manufacturing method is comprised of:
a step in which phosphorus is diffused into said silicon membrane whereby an average value of the concentration of phosphorus in the silicon membrane is made between 5×10¹⁸ atom/cm³ and 1×10²⁰ atom/cm³; the concentration of phosphorus in said silicon membrane is made uniform; and a uniformity of the phosphorus concentration is made lower than, or equal to 20%.

6. A manufacturing method of manufacturing a transfer mask comprising: a supporting substrate having a strut; a silicon oxide layer formed on the supporting substrate; and a silicon membrane which is formed on the silicon oxide layer, and on which a pattern is formed; wherein:
the manufacturing method is comprised of:
a step in which phosphorus is diffused into said silicon membrane whereby an average value of the concentration of phosphorus in the silicon membrane is made between 5×10¹⁸ atom/cm³ and 1×10²⁰ atom/cm³; the concentration of phosphorus in the silicon membrane is made uniform; and a uniformity of the phosphorus concentration is made lower than, or equal to 20%.

7. A method of manufacturing a transfer mask blank as claimed in claim 5, or a method of manufacturing a transfer mask as claimed in claim 6, wherein:
the manufacturing method is comprised of: a step for anneal-processing said transfer mask blank within an active gas atmosphere.
